(19) United States
(12) Patent Application Publication
(10) Pub. No.: US 2017/0237369 A1
(43) Pub. Date: Aug. 17, 2017

(54) ELECTRIC POWER-GENERATING SYSTEM FOR A ROTOR BLADE, LIGHTING SYSTEM FOR A ROTOR BLADE, ROTOR BLADE AND ROTOR SYSTEM

(71) Applicant: Airbus Defence and Space GmbH, Ottobrunn (DE)

(72) Inventors: Thomas T Becker, Osterholz-Scharmbeck (DE); Johannes Sebald, Ritterhude (DE)

(21) Appl. No.: 15/427,216

(22) Filed: Feb. 8, 2017

(30) Foreign Application Priority Data
Feb. 11, 2016 (DE) 102016202066.8
Nov. 14, 2016 (DE) 102016222265.1

(51) Int. Cl. H02N 2/18; B64D 47/02; B64C 27/473

(52) U.S. Cl. CPC H02N 2/18; B64C 27/473; B64D 47/02; B64D 2221/00

(57) ABSTRACT

An electric power-generating system for a rotor blade includes at least one electromechanical power-converting device and at least one power-guide line, which is connected mechanically to the electromechanical power-converting device. The electromechanical power-converting device is configured in such a way that, during a movement of the power-guide line, the device converts into electric power the forces introduced by the movement of the power-guide line into the electromechanical power-converting device.

### CROSS-REFERENCES TO RELATED APPLICATIONS

This application claims the benefit of the German patent application No. 102016202066.8 filed on Feb. 11, 2016, and of the German patent application No. 102016222265.1 filed on Nov. 14, 2016, the entire disclosures of which are incorporated herein by way of reference.

### FIELD OF THE INVENTION

The invention relates to an electric power-generating system for a rotor blade, to a lighting system for a rotor blade, to a rotor blade and to a rotor system.

### BACKGROUND OF THE INVENTION

Modern helicopters comprise a plurality of electrically operated components, such as lighting devices, sensors, control devices or the like. Usually, electric components are also required in regions which are difficult to reach with electric power lines. In particular, rotating components are also required, such as the rotor or rotor blades. As there are considerable risks associated with using rotating rotor blades, devices are known from the prior art by means of which the external outline of rotating rotor blades can be displayed visually and thus made recognizable.

For example from WO 2008/111932 A1, an autonomous blade tip light is known for rotor blades, in which the lighting is provided by means of light-emitting diodes and in which the electric power required for powering the light-emitting diode is provided piezoelectrically. The movement of the rotor blades is used for the piezoelectric power supply in that the vibrations of the rotor blades are converted piezoelectrically into current.

Also from DE 20 2008 008 517 U1, an energy self-sufficient lighting system for rotor blade tips is known, in which the electric power required for powering the light source is provided by an energy supply unit arranged in the rotor blade, which, during the operation of the rotor blade, produces electric current from the vibrations thereof.

### SUMMARY OF THE INVENTION

One of the ideas of the present invention is to provide an electric power-generating system for a rotor blade which ensures a reliable and effective power supply to electrically powered functional components.

According to a first aspect of the present invention, an electric power-generating system for a rotor blade is provided. The system comprises at least one electromechanical power-converting device and at least one power-guide line, which is connected mechanically to the electromechanical power-converting device. The electromechanical power-converting device is designed in such a way that, during a movement of the power-guide line, the device converts into electric power the forces introduced by the movement of the power-guide line into the electromechanical power-converting device.

The electric power-generating system thus comprises one or more devices for providing electric power in the form of electromechanical power-converting devices. One or more power-guide lines are assigned respectively to a power-converting device. The power-guide lines or movement bands are coupled kinematically to the power-converting device. When charging the at least one power-guide line with force, for example caused by the movement of the rotor blade, the force is introduced by means of the power-guide line or power-guiding band into the power-converting device. The mechanical power supplied in this way to the power-converting device is converted by the power-converting device into electric power.

By means of the movement of the power-guide line, in particular, tensile forces are exerted on the electric power-converting device, wherein also transverse forces from the movement of the power-guide line can be transmitted to the electric power-converting device. The movement of the power-guide line can be caused, on the one hand, by the forces exerted by the rotor blade on the power-guide line, for example due to the inertia of the power-guide line and due to rotations of the rotor blade, or in particular by aerodynamic forces acting on the power-guide line, wherein as a rule, various forces act on the power-guide line. In this case, the power-guide line has the advantage that the line can absorb strong tensile forces and thereby ensures an efficient power conversion.

In the solution according to the invention, greater forces can be exerted on the electromechanical power-converting device by the power-guide line excited by means of the rotor-blade movement than by the vibrations of the rotor blade alone, so that more power can be converted. In this way, either the number of electromechanical power-converting devices per rotor blade can be reduced, or additional or more light-intense electric functional components can be used.

According to some embodiments, the at least one power-guide line can be connected, in particular, directly to the electromechanical power-converting device. For this purpose, it can be provided, for example, that the power-guide line runs in an uninterrupted manner between a first end facing away from the electromechanical power-converting device and a second end mechanically connected to the electric power-converting device. In this way, a simpler structure of the power-converting system is ensured.

Alternatively to this, it is possible to arrange an electric functional component mechanically between two line portions, e.g., between the first and the second end of the power-guide line or between one of the ends of the power-guide line and the electromechanical power-converting device, so that the electric functional component can be arranged in the force flow itself. In this way, it is ensured that only a small amount of installation space is required. In particular, it is possible to omit electrical supply lines, which also reduces the weight advantageously.

Furthermore, it is possible for the first and the second end of the power-guide line to each be connected directly to the electromechanical power-converting device. In this way, the power-guide line forms a loop. In cases where the power-guide line runs outside of the rotor blade, the loop causes a relatively high degree of air resistance and thus a high tractive force on the power-guide line. In this way, the performance of the power-generating system is improved.

The power-guide line or the power-guiding band can be made, in particular, from a plastics material, for example a polymer material. Plastics materials, in particular polymers, are available in numerous different variations and have a high degree of mechanical strength. A further advantage of plastics materials, in particular polymers, is that the materials can be produced with various different refractive indices. In this way, the power-guide line can be designed advantageously and in a simple manner as an optical fiber. Furthermore, nanotubes embedded in a plastics matrix can also be used advantageously as a material for the power-guiding band. Weaves of metal material can also be used as power-guide lines. The weaves can be produced particularly inexpensively and have a high degree of mechanical stability.

In some embodiments, it is possible for the electromechanical power-converting device to comprise at least one piezo element connected mechanically to the power-guide line for converting mechanical power from the movement of the power-guide line into electric power. The electromechanical power-converting device thus converts the mechanical power from the movement of the power-guide line through the effect of one or more piezo elements into electric power. The piezo elements convert the mechanical alternating forces exerted by the power-guide line on the power-converting device into electric power. The electric power can be used advantageously for powering the electrically powered functional components, for example in the form of light sources. For example, one piezo element can be provided for each power-guide line. However, it is also conceivable to provide only one piezo element for a plurality of power-guide lines.

In this case, the power-guide line can be secured directly or via further connecting elements to the respective piezo element.

According to some embodiments, it is possible for the power-guide line to be surrounded, at least in some portions, by a piezo electric material of the piezo element. In this way, a particularly high degree of conversion efficiency of the mechanical movement of the power-guide line into electric power is achieved.

According to some embodiments, the piezo elements can be configured, in particular, in such a way that the elements surround the power-guide line with regard to the longitudinal extension thereof at least in some portions. The forces from the movement of the power-guide line are then introduced to the surrounding piezo element, for example in a planar manner, where the power-guide line is connected to the surrounding piezo element. For this, for example PVDF-nanocomposites, i.e., polyvinylidene fluoride nanocompo sites, are used. Furthermore, also at least one end portion of the power-guide line can be embedded into the piezoelectric material or received thereby.

For all the embodiments, in particular what are known as “conformable piezoelectric polymers” can be used as the piezoelectric material, such as polyvinylidene fluoride (PVDF), polyvinylidene fluoride-co-trifluoroethylene) (P(VDF-TrFE)) or materials based on what are known as carbon nanotubes (CNT base).

According to some embodiments, the electric power-generating system comprises at least one energy store connected electrically to the electromechanical power-converting device for storing electric power. In this way, the power converted during the movement of the rotor blade can be stored temporarily in order to supply an electrically operating functional component with electric power even when the rotor blades are rotating at a relatively low speed, or to supply the component with electric power temporarily even when the rotor has stopped.

The energy store can be designed, in particular, as a capacitor, as an accumulator or as a similar storage device for electric power.

According to some embodiments, the electric power-generating system also comprises an electronic control device, by means of which the provision of electric voltage produced by means of the electromechanical power-converting device can be switched on or off at electric connection points of the power-generating system provided for connecting electric functional components. The electric power-generating system thus comprises an electronic system, by means of which electric functional components which are connectable to the system can be switched on or off. In this way, the possible applications of the functional components are improved.

In some embodiments, the control device can be controlled wirelessly. For example, the control device can be designed to be controlled by radio signals. However, other control options are also possible, for example optical signals or acoustic signals. Furthermore, the control device can comprise brightness sensors or the like, which at a specific brightness switch on or off the supply of electric voltage. By means of the wireless control, the electric power-generating system can be controlled and operated advantageously without control lines.

According to a further aspect of the invention, a lighting system for a rotor blade is provided. The lighting system comprises an electric power-generating system according to any of the aforementioned embodiments and at least one electric light source, which is connected electrically to the power-converting device of the electric power-generating system. The electric power produced by the power-generating system is then used advantageously for operating an electric light source. Due to the high efficiency of the power conversion of the power-generating system, it is possible to use powerful light sources.

According to a some embodiments of the lighting system, the power-guide line of the power-generating system is in the form of an optical fiber, and the power-guide line is connected mechanically to the light source in such a way that the light source introduces light into the power-guide line, and the light source is connected to the electromechanical power-converting device mechanically in such a way that the forces produced by the movement of the power-guide line are transmitted via the light source to the electromechanical power-converting device. The light produced by the light source is then transmitted through the power-guide line in the form of an optical fiber from a first line end to a second line end which is positioned opposite the first end. In this case, the first line end is the end of the power-guide line placed at the light source, the second line end is the end facing away from the light source or the electromechanical power-converting device. The light source is also connected mechanically to the electromechanical power-converting device. The forces produced by the movement of the power-guide line, which is caused, for example, by the movement of a rotor blade, are thereby transmitted by the light source, which is arranged mechanically in the force flow, to the device for providing electric power, which converts mechanical power into electric power.

In some embodiments, the power-guide line is thus used, on the one hand, for generating forces for the electromechanical power-converting device and, on the other hand, also for transmitting the light produced by the light source. In this way, the light source can also be arranged inside the rotor blade, for example in the immediate vicinity of or directly on the electromechanical power-converting device, and the light is transmitted through the power-guide line in the form of an optical fiber to the outside of the rotor blade. For example, the power-guide line can have such a length that the second line end is positioned outside a rotor blade, so that the power-guide line can move in part outside of the rotor blade. This ensures the easily identifiable lighting of the rotor blade. By using the aforementioned power-converting system, particularly bright light sources can be used.

In some embodiments, the at least one light source comprises respectively at least one light-emitting diode. By means of light-emitting diodes with low power consumption, a high light output can be achieved, and the light can be fed effectively into an optical fiber if necessary. Furthermore, light-emitting diodes are mechanically robust, e.g., with respect to vibrations and accelerations, when arranged on a rotor blade. Also light-emitting diodes are advantageous for the mechanical transmission of forces, for example if they are arranged between a line end of a power-guide line in the form of an optical fiber and the electromechanical power-converting device. However, also other light sources suitable for the purpose can be used.

According to some embodiments of the lighting system, the light source can be arranged on the inside of a rotor blade. The light source is thus provided in particular to be arranged within the cross section of the rotor blade. In this way, the lighting can be achieved without having aerodynamically unfavorable attachments on the outer surface of the rotor blade.

In some embodiments, the light source can be provided to be arranged in a depth-balancing chamber of the rotor blade. This has the advantage that the installation space inside the cross section is used efficiently. In this way, a compact structure of the lighting system is obtained, and a structural reconfiguration of the rotor blade can be largely avoided.

According to a further aspect of the present invention, a rotor blade is provided, in particular for an aircraft. The rotor blade comprises an electric power-generating system according to any of the embodiments described above. The electric power-generating system thus forms an electric power source provided locally on the rotor blade. In this way, vibrations caused by the rotation of the rotor blade due to the power-guide line of the electric power-generating system are converted in a particularly efficient manner into electric power. The power-guide line forms in particular a kind of lever which increases the force acting on the electromechanical power-converting device.

According to some embodiments of the rotor blade, the at least one power-guide line runs at least in portions outside a rotor blade, in particular outside a cross section of the rotor blade. In this case, the power-guide line extends at least in part into a fluid surrounding an outer contour of the rotor blade. In this way, during a movement of the rotor blade, in a particularly efficient manner, a force is exerted onto the power-guide line, in particular a tensile force. The power introduced by the force into the electromechanical power-converting device is then converted by the device into electric power.

For example, it is possible for the power-guide line to project with an end portion, for example the second line end facing away from the electromechanical power-converting device, out of the cross section of the rotor blade. It is also possible for a middle portion between the first and second line end to run outside of the rotor blade. In this way, the portion of the line running outside the rotor blade forms a flow resistance and, in addition to the forces of inertia, which also act on the line portion arranged in the rotor blade, aerodynamic forces from the movement of the rotor blade act on the line portion projecting from the rotor blade. In this way, the forces acting on the power-guide line are increased, and a greater amount of mechanical power is introduced into the device for providing electric power and converted into electric power. In this way, the performance of the lighting device is improved.

Furthermore, it is conceivable for the power-generating system to be attached as a whole onto an outer surface of the rotor blade, for example onto the rotor blade tip.

In some embodiments, however, the electromechanical power-converting device is arranged on the inside of the rotor blade, in particular in a depth-balancing chamber of the rotor blade. Thus, the electromechanical power-converting device is arranged on the inside of the cross section of the rotor blade, such as in a depth-balancing chamber of the rotor blade. This has the advantage that the influence of the power-generating system on the aerodynamic properties of the rotor blade is kept to a minimum.

In general, a plurality of electric power-generating systems can be provided, which may be distributed over the longitudinal extension of the rotor blade. For example, the systems can be connected electrically in parallel or in series. In this way, a particularly efficient power supply can be obtained for electrically powered functional components.

A further aspect of the invention relates to a rotor system, in particular for an aircraft, comprising at least one rotor blade according to any of the embodiments described above and comprising at least one electrically powered functional component, which is connected electrically to the power-converting device of the electric power-generating system. By means of the power-converting device, the force produced by the movement of the rotor blade on the power-guide line is converted efficiently into electric power, which is used to supply the electrically powered functional components.

In some embodiments, a light source, a sensor, an actuator device or the like can be provided as an electrically powered functional component. Light sources advantageously allow the lighting of the rotor blade, in particular the blade tip thereof, so that a danger region covered during the movement of the rotor blade is marked clearly visually. Sensors can be used advantageously for detecting aerodynamic or mechanical parameters. By means of actuator devices, for example mechanical systems can be activated on the rotor blades.

The rotor system may comprise a light source as an electrically powered functional component. According to some embodiments of this type of the rotor system, the at least one rotor blade optionally comprises additional rotor components, such as a rotor shaft or the like, as well as an embodiment of the aforementioned lighting system. In this case, for example a plurality of light sources can be provided which are preferably arranged so as to be distributed over the number of rotor blades. For example one or more light sources can be arranged on each rotor blade of a rotor. In this case, the light sources are preferably arranged on the rotor blade tips or in the vicinity thereof. The at least one light source can thus be arranged in general in an end portion of the rotor blade which is axial to the longitudinal extension of the rotor blade. The at least one electric light source is connected electrically to one or more electromechanical power-converting devices of the electric power-generating system.

### BRIEF DESCRIPTION OF THE DRAWINGS

The invention is explained in the following with reference to the figures of the drawings, in which:

FIG. 1 is a schematic view of a rotor system according to a preferred embodiment of the present invention;

FIG. 2 is a schematic view of a power-generating system according to a preferred embodiment of the present invention;

FIG. 3 is a schematic view of a power-generating system according to a further embodiment of the present invention;

FIG. 4 is a schematic view of a power-generating system according to a further embodiment of the present invention; and

FIG. 5 is a schematic view of a rotor system according to a further embodiment of the present invention, in which a power-guide line of the power-generating system is in the form of an optical fiber.

In the figures, the same reference numerals denote identical or functionally similar components, unless otherwise indicated.

### DETAILED DESCRIPTION OF THE PREFERRED EMBODIMENTS

FIG. 1 shows by way of example a rotor system 100. The rotor system 100 comprises at least one rotor blade 10 comprising an electric power-generating device 1 as well as an electrically powered functional component 40, which is connected electrically to the electric power-generating device 1.

The rotor system 100 shown schematically and by way of example in FIG. 1 is illustrated as a rotor system for an aircraft 200. In particular, the rotor system 100 in this case comprises a rotor shaft 101 rotatable about an axis of rotation R100, which is connected to a fuselage structure 201 of the aircraft 200 and which supports the at least one rotor blade 10 as well as possibly additional rotor blades.

For example, a light source 41, 42, a sensor 43, an actuator device 44 or the like can be provided as the electrically powered functional component 40. FIG. 1 shows by way of example a light source 41 arranged on a rotor blade tip 13 of the rotor blade 10, a sensor 43 arranged on an actuator rod 103 of a wobble plate 102 assigned to the rotor shaft 101, as well as an actuator device 44 arranged on the wobble plate 102. The functional components 40 are each connected via an electrical supply line 4 to the electric power-generating system 1 of the rotor blade 10.

As shown in FIG. 1, the rotor blade 10 comprises the electric power-generating system 1. In the rotor blade 10 shown by way of example in FIG. 1, the power-generating system 1 is arranged in an end portion 11 of the rotor blade 10 facing away from the longitudinal extension or longitudinal direction L10 of the rotor blade 10 relative to the rotor shaft 101. As shown schematically in FIG. 1, the power-generating system 1 comprises at least one electromechanical power-converting device 3 and at least one power-guide line 5. The power-guide line 5 is connected mechanically to the electromechanical power-converting device 3. The electromechanical power-converting device 3 is configured in such a way that during a movement of the power-guide line 5, the device converts into electric power the forces introduced by the movement of the power-guide line 5 into the electromechanical power-converting device 3. As shown schematically in FIG. 1, it can be provided, in particular, that the at least one power-guide line 5 runs at least in portions outside a rotor blade 10. During a rotation of the rotor blade 10 about the axis of rotation R100, the power-guide line 5 is drawn behind the rotor blade 10. Due to the flow of fluid around the rotor blade 10, which fluid comprises air in the case of an aircraft, a tensile force is generated on the power-guide line 5. In particular, if the power-guide line projects into a trailing region of the rotor blade 10, a type of fluttering movement of the power-guide line 5 is initiated by means of turbulence. The mechanical power of the movement of the power-guide line 5 is converted by the electromechanical power-converting device 3 into electric power.

As is also shown in FIG. 1, the electromechanical power-converting device 3 is preferably arranged on the inside of the rotor blade 10. FIG. 1 shows by way of example a configuration of the rotor blade 10, in which the electromechanical power-converting device 3 is arranged in a depth-balancing chamber 12 of the rotor blade 10, and an end portion 5b of the power-guide line 5 projects out of the depth-balancing chamber 12.

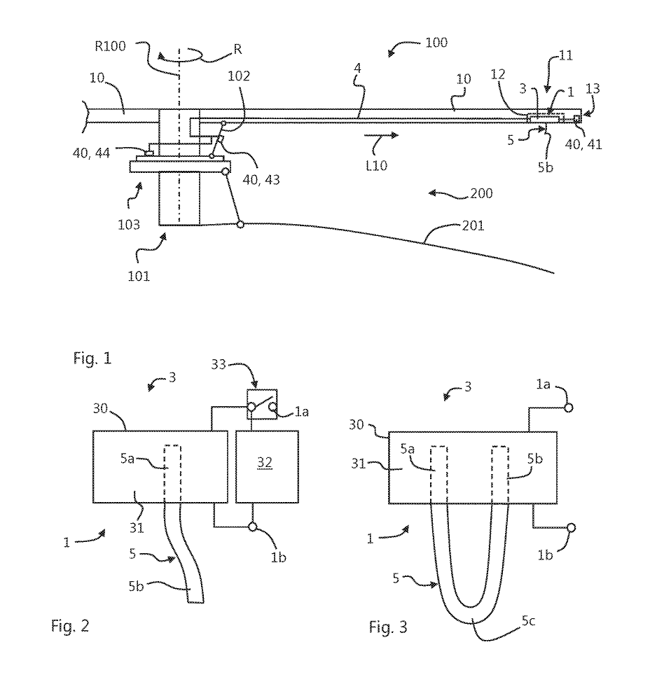

FIGS. 2 to 4 show respectively advantageous configurations of the electric power-generating system 1. In the examples shown in FIGS. 2 to 4, the electromechanical power-converting device 3 comprises a respective piezo element 30, which is coupled mechanically to the power-guide line 5. In the examples shown in FIGS. 2 to 4, the mechanical coupling is achieved in that the power-guide line is surrounded at least in portions by a piezoelectric material 31 forming the piezo element 30.

In the power-generating system 1 shown in FIG. 2, a first end portion 5a of the power-guide line 5 is embedded into the piezoelectric material 31, and a second end portion 5b of the power-guide line 5 which is opposite in relation to the longitudinal extension or the line longitudinal direction L5 of the power-guide line 5 is arranged to be freely movable outside the piezoelectric material 31. In FIG. 2, the piezo element 30 is shown by way of example as a block. On the piezo element 30, electrodes (not shown) are provided, where the voltage produced by means of the deformation caused by the power-guide line 5 can be tapped. For this purpose, connection points 1a, 1b are provided, which are shown schematically in FIG. 2. The connection points are provided for the connection of the electric functional components 40. In FIG. 2, by way of example, a configuration of the piezo element 30 is shown in which a first connection point 1a forms a positive electric pole and a second connection point 1b forms a negative electric pole.

Furthermore, FIG. 2 shows schematically an optional electronic control device 33. The device forms a switch in a functional respect, by means of which the provision of electric voltage to the electric connection points 1a 1b can be switched on or off Preferably, the control device 33 can be controlled wirelessly. According to the view shown by way of example in FIG. 2, the control device 33 is designed as a switch assigned to the first connection point 1a. The control device 33 can be controlled for example by radio to switch on or off the electrically powered functional components 40.

As is also shown in FIG. 2, the power-generating system 3 can optionally comprise an energy store 32 connected to the electromechanical power-converting device 3 for storing electric power produced by means of the electromechanical power-converting device 3.

For the sake of clarity in FIG. 3, the optional control device 33 and the optional electric energy store 32 are not shown. Unlike the view in FIG. 2, in FIG. 3 the first end portion 5a of the power-guide line 5 and the second end portion 5b of the power-guide line 5 respectively are embedded into the piezoelectric material 31. A central region 5c extending between the first and second end portion 5a, 5b extends as a loop outside the piezoelectric material 31. When installed in the rotor blade 10, the central region 5c projects out of the rotor blade 10.

Alternatively to embedding at least one of the end portions 5a, 5b of the power-guide line, as shown in FIGS. 2 and 3, the mechanical coupling between the power-guide line 5 and the piezo element 30 can also be achieved respectively by connecting means connecting the piezo element 30 and the respective end portion 5a, 5b. For example, the respective end portion 5a, 5b can be adhered, welded or connected in a similar manner to the piezo element 30.

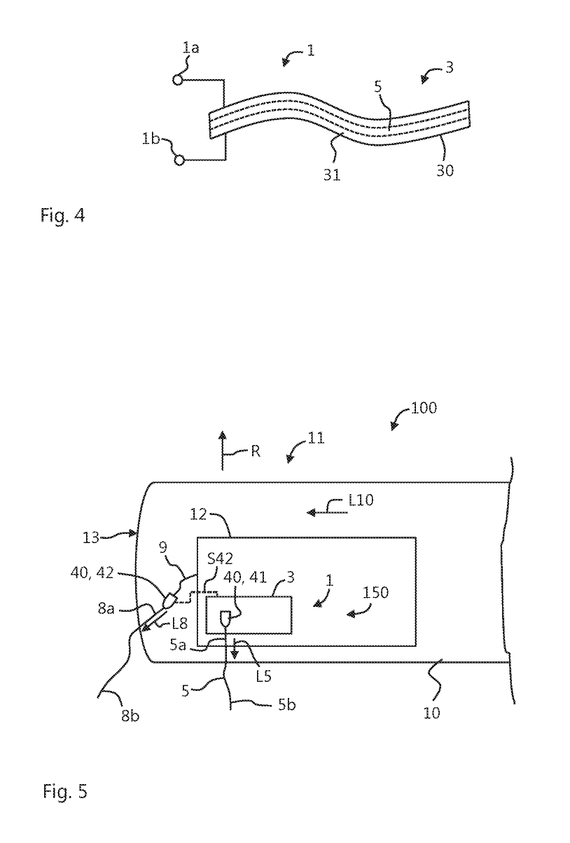

FIG. 4 shows by way of example and schematically a configuration of the electromechanical power-converting device 3 as a piezo element 30, which is designed as a tube surrounding the power-guide line 5. In FIG. 4, the piezoelectric material 31 of the piezo element 30 surrounds the power-guide line over the whole longitudinal extension thereof. Alternatively, it can be provided that the piezoelectric material 31 surrounds only one or more portions of the power-guide line 5 in the manner of a tube. By means of the tube-like design of the piezo element 30, a particularly high degree of conversion efficiency is achieved. The electromechanical power-converting device 3 designed in this way is particularly suitable for securing to an outer surface of the rotor blade 10. This has the advantage that hardly any structural changes need to be made to the rotor blade 10. In this way, the power-generating system 1 can be retrofitted in a simple manner.

FIG. 5 shows a further embodiment of the rotor system 100. The system differs from the rotor system 100 shown in FIG. 1, in particular in the structure of the electric power-generating system 1, which is produced in the embodiment shown in FIG. 5 as part of a lighting system 150. The electric power-generating system 1 can, as shown in FIGS. 1 and 5, be arranged with respect to a longitudinal extension L10 of a rotor blade 10 on the end portion 11 thereof. The power-generating system 1 comprises the electromechanical power-converting device 3, which can be arranged, for example, in the depth-balancing chamber 12 in the vicinity of the rotor blade tip 13 of the rotor blade 10. Furthermore, the power-generating system 1 comprises the at least one power-guide line 5, which is connected mechanically to the electromechanical power-converting device 3.

The electromechanical power-converting device 3 is arranged according to the illustration given by way of example in FIG. 5 within the cross section of the rotor blade 10, namely in the depth-balancing chamber 12.

The lighting system 150 shown by way of example in FIG. 5 comprises the electric power-generating system 1 as well as at least one light source 41, 42 connected electrically to the electromechanical power-converting device 3 of the power-generating system 1. In the lighting system 150 shown by way of example in FIG. 5, two electric light sources 41, 42 are provided as electrically powered functional components 40 of the rotor system 100. The power-guide line 5 is connected mechanically by the first line end 5a to the electromechanical power-converting device 3. A second line end 5b positioned opposite the first line end 5a is placed outside the cross section of the rotor blade 10, as shown in FIG. 5.

The light sources 41, 42 are each connected electrically to the electromechanical power-converting device 3. Preferably, the electric light sources 41, 42 are arranged respectively within the cross section of the rotor blade 10, as shown by way of example in FIG. 5. In particular, the light sources 41, 42 can be designed as light-emitting diodes. The light source 41 is shown by way of example in FIG. 5 arranged inside the depth-balancing chamber 12, the light source 42 is arranged according to the illustration given by way of example in FIG. 5 outside the depth-balancing chamber 12. Of course, also both light sources 41, 42 can be arranged inside or outside the depth-balancing chamber 12.

In the lighting system shown in FIG. 5, a power-guide line 5 designed as a first optical fiber is secured to the light source 41. The power-guide line projects in the shown embodiment out of the rotor blade 10 and thereby flutters irregularly in the air flow during the movement of the rotor blade 10, for example during a rotation thereof about the axis of rotation R100 in a direction of rotation R. In this way, the power-guide line 5 exerts forces via the light source 41 on the electromechanical power-converting device 3 comprising, e.g., a piezo element (not shown in FIG. 5). The electromechanical power-converting device 3 converts the mechanical power from the movement of the power-guide line 5 into electric power, e.g., by means of the piezo elements, and thereby supplies the light source 41 with electric power. The light fed by the light source 41 into the power-guide line 5 designed as an optical fiber is directed by the line to the second line end 5b placed outside the rotor blade 10, exits, in particular, at the end of the power-guide line 5 and thereby generates a signal effect which displays a movement of the rotor blade 10. The power-guide line 5 can be guided out of the rotor blade 10, in particular, in such a way that the line can move along the longitudinal direction L5 thereof, whereby an optimum force effect is exerted for the production of electricity on the electromechanical power-converting device.

The light source 42 shown in FIG. 5 is fixed by means of an additional securing line 9 onto a wall of the depth-correcting chamber 12. However, other methods of attachment are also conceivable, such as fixing the light source 42 directly onto the wall of the depth-correcting chamber 12 or to another point of the rotor blade 10. The electric power required for the light source 42 is also supplied by the electromechanical power-converting device 3, to which the light source 42 is connected electrically. This electrical connection is shown schematically in FIG. 5 by the dash-dotted line S42. The securing line 9 can of course be coupled mechanically to an electromechanical power-converting device 3, so that the device forms a portion of a power-guide line.

As also shown in FIG. 5, the light source 42 is connected mechanically to a second optical fiber 8. In particular, the light source 42 is connected mechanically to the second optical fiber 8 in such a way that the light source 42 introduces light into the fiber. For this purpose, the light source 8 is connected to a first end portion 8a of the second optical fiber 8. The second optical fiber 8 projects with a second end portion 8b, which is opposite the first end portion 8a with respect to the longitudinal extension or the line longitudinal direction L8 of the optical fiber 8, out of the rotor blade 10, preferably directly out of the rotor blade tip 13 thereof. When guiding the second optical fiber 8 out directly on the rotor blade tip 13, an effective signal and warning effect is achieved directly on the rotor blade tip 13, in addition to the light emitted by the first optical fiber 5. The optical fiber 8 exiting at the rotor blade tip 13 thus displays the outer limitation of the rotor blade movement.

As already described, it is also possible for the securing line 9 to be connected mechanically to the electromechanical power-converting device 3. In this case, the second optical fiber 8 and the securing line 9 each form a portion of a power-guide line 5.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An electric power generating system for a rotor blade, comprising:
at least one electromechanical power-converting device; and
at least one power-guide line connected mechanically to the electromechanical power-converting device, the electromechanical power-converting device being configured in such a way that, during a movement of the power-guide line, the electromechanical power-converting device converts into electric power the forces introduced by the movement of the power-guide line into the electromechanical power-converting device.

2. The electric power generating system of claim 1, wherein the electromechanical power-converting device comprises at least one piezo element connected mechanically to the power-guide line for converting mechanical energy from the movement of the power-guide line into electric power.

3. The electric power generating system of claim 2, wherein the power-guide line is surrounded at least in portions by piezoelectric material of the piezo element.

4. The electric power generating system of claim 1, further comprising:
at least one energy store connected electrically to the electromechanical power-converting device for storing electric energy.

5. The electric power generating system of claim 1, further comprising:
an electronic control device configured to selectively activate the production of electric power at electric connection points for connecting an electric functional component.

6. The electric power generating system of claim 5, the electronic control device being configured to be wirelessly controllable.

7. A lighting system for a rotor blade, comprising:
an electric power generating system including at least one electromechanical power-converting device, and at least one power-guide line connected mechanically to the electromechanical power-converting device, the electromechanical power-converting device being configured in such a way that, during a movement of the power-guide line, the electromechanical power-converting device converts into electric power the forces introduced by the movement of the power-guide line into the electromechanical power-converting device; and
at least one electric light source connected electrically to the power-converting device of the electric power generating system.

8. The lighting system of claim 7, the power-guide line comprising an optical fiber, and the power-guide line being connected mechanically to the light source in such a way that the light source introduces light into the power-guide line, the light source being connected mechanically to the electromechanical power-converting device in such a way that the forces produced by the movement of the power-guide line are transmitted via the light source to the electromechanical power-converting device.

9. The lighting system of claim 7, wherein the at least one light source comprises at least one light emitting diode.

10. A rotor blade, comprising:
an electric power generating system including at least one electromechanical power-converting device, and at least one power-guide line connected mechanically to the electromechanical power-converting device, the electromechanical power-converting device being configured in such a way that, during a movement of the power-guide line, the electromechanical power-converting device converts into electric power the forces introduced by the movement of the power-guide line into the electromechanical power-converting device.

11. The rotor blade of claim 10, further comprising:
a light source arranged in a depth-balancing chamber of the rotor blade.

12. The rotor blade of claim 10, wherein the at least one power-guide line runs outside the rotor blade at least in portions.

13. The rotor blade of claim 10, wherein the electromechanical power-converting device is arranged in a depth-balancing chamber of the rotor blade.

14. A rotor system, comprising:
at least one rotor blade including an electric power generating system including at least one electromechanical power-converting device, and at least one power-guide line connected mechanically to the electromechanical power-converting device, the electromechanical power-converting device being configured in such a way that, during a movement of the power-guide line, the electromechanical power-converting device converts into electric power the forces introduced by the movement of the power-guide line into the electromechanical power-converting device; and
at least one electrically powered functional component connected electrically to the power-converting device of the electric power generating system.

15. The rotor system of claim 14, wherein the electrically powered functional component comprises one or more of a light source, a sensor and an actuator device.
